(19) United States
(12) Patent Application Publication
(10) Pub. No.: US 2025/0166241 A1
(43) Pub. Date: May 22, 2025

(54) GENERATING IMAGES BY EXPANDING PROMPTS USING GENERATIVE NEURAL NETWORKS

(71) Applicant: Google LLC, Mountain View, CA (US)

(72) Inventors: Deepak Ramachandran, Sunnyvale, CA (US); Alexander Ku, Princeton, NJ (US); Peter James Anderson, Austin, TX (US); Siddhartha Datta, Austin, TX (US)

(21) Appl. No.: 18/950,898

(22) Filed: Nov. 18, 2024

Related U.S. Application Data
(60) Provisional application No. 63/600,642, filed on Nov. 17, 2023.

(51) Int. Cl. G06T 11/00; G06F 16/33

(52) U.S. Cl. CPC G06T 11/00; G06F 16/3338

(57) ABSTRACT

Methods, systems, and apparatus, including computer programs encoded on a computer storage medium, for generating images. In one aspect, a method comprises: obtaining an input query comprising text; processing, using prompt expansion model, a model input comprising at least the input query to generate a set of expanded prompts of the input query, wherein each of the expanded prompts describes an image in more detail than the input query; and for one or more of the expanded prompts in the set, generating, using an image generation model, a respective image that represents the expanded prompt.

### CROSS-REFERENCE TO RELATED APPLICATIONS

This application claims priority to U.S. Provisional Application No. 63/600,642, filed on Nov. 17, 2023. The disclosure of the prior application is considered part of and are incorporated by reference in the disclosure of this application.

### BACKGROUND

This specification relates to generating images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates images from prompts using one or more generative neural networks.

Particular embodiments of the subject matter described in this specification can be implemented so as to realize one or more of the following advantages.

Generating high-quality images using conventional text-to-image models often requires an input prompt to include details that may be difficult for users to conceive of such as arcane jargon, extreme descriptors, and/or social media tags. In addition, input prompts that lead to high-quality images for a particular text-to-image model may not lead to high-quality images for other text-to-image models, or different versions of the particular text-to-image model.

To address these issues, the system described in this specification can generate high-quality images for a given prompt by using a prompt expansion model to generate expanded prompts that describe visual features and additional details such as aesthetics, styles, and/or composition.

The system described in this specification can generate multiple high-quality, diverse images given a single prompt. For example, the single prompt may not include details that describe the subject of the image or visual details and, as a result, there may be multiple diverse images, e.g., images with different subjects or different visual details, that satisfy the requirements of the prompt. The system can process the given prompt using a prompt expansion model to generate a set of expanded prompts. Each of the expanded prompts can include, for example, keywords describing visual features, additional details, or some phrases from the given prompt. The system can then generate images for the expanded prompts using an image generation model, such as a text-to-image model.

Furthermore, text-to-image models often do not generate diverse images. For example, randomly sampling multiple images for a prompt may produce similar outputs that do not have much variance in aspects such as composition, style, viewpoint, lighting, and other features. This lack of diversity can fail to lead the user towards more interesting imagery.

The system described in this specification can generate a greater variety of diverse images by sampling within text space for the expanded prompts, resulting in increased diversity, e.g., topical diversity, semantic diversity, or expressive diversity. The additional details of the expanded prompts can add diversity to the generated images by describing image characteristics that are unspecified or underspecified in the input prompt. The expanded prompts can include visual features such as composition, viewpoint, or lighting. The expanded prompts can also describe details that are unspecified in the input prompt such as subjects to depict, pose, action, point-of-view, background, colors, topic, location, etc.

The system described in this specification can reduce the burden on the user of prompt sharing or prompt engineering, or the process of iterating over prompts to craft an optimal text prompt for a desired image. The system can also reduce the cognitive load for the user. For example, rather than iterating over potential prompts to generate the desired image, the user can simply select the image they prefer. The system can thus provide for efficient and user-friendly interaction with text-to-image models.

Furthermore, by minimizing the process of iterating over prompts to craft an optimal text prompt for a desired image, the system can reduce the amount of computing resources used, for example, in generating images for each of the iterations of prompts. For example, as the system provides multiple different images for one given input prompt from the user, the system can increase the likelihood that the images satisfy the user's request, reducing the likelihood of further iterations of making further calls to the text-to-image model to generate images for different iterations of input prompts. As another example, in implementations where the text-to-image model executes on one or more computers remote from the user device, the system can preserve the network bandwidth that is otherwise needed to transmit prompt data and image data over multiple iterations.

The system described in this specification can generate high-quality and diverse images without having to train the prompt expansion model or the text-to-image model from scratch, and without having to generate large amounts of training data for training the models from scratch. For example, the prompt expansion model can be a pre-trained language model that is fine-tuned or prompt-tuned to generate expanded prompts. The text-to-image model can also be a pre-trained image generation neural network.

The system described in this specification can also generate expanded prompts that remain faithful to details within the input prompt while adding other details. For example, the system can include one or more sub-phrases of the input prompt in the expanded prompts to ensure adherence to the input prompt.

In some implementations, the system described in this specification can generate expanded prompts that are optimized for the particular text-to-image model that is used. For example, some text-to-image models may not be able to successfully render all aspects, e.g., a particular style, of a given prompt. The prompt expansion model can be further trained on a filtered probing set, also referred to as model-specific tuning data, for a particular text-to-image model, so that the prompt expansion model can generate expanded prompts that include aspects of images that the particular text-to-image model can successfully render. Thus, the system can use the further trained prompt expansion model to generate expanded prompts that are optimized for the particular text-to-image model, and provide the expanded prompts as input to the particular text-to-image model to generate high-quality images that depict the aspects of the input expanded prompts.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example image generation system.

FIG. 1B is a block diagram of another example image generation system.

FIG. 2 is a flow diagram of an example process for generating images.

FIG. 3 shows an example process for generating tuning data for further training a prompt expansion model.

FIG. 4 shows an example process for generating an image using multiple expanded prompts.

Like reference numbers and designations in the various drawings indicate like elements.

### DETAILED DESCRIPTION

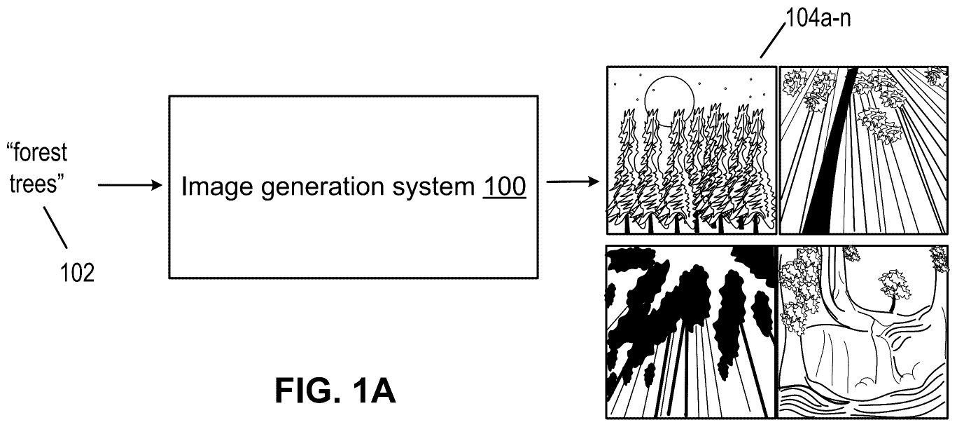

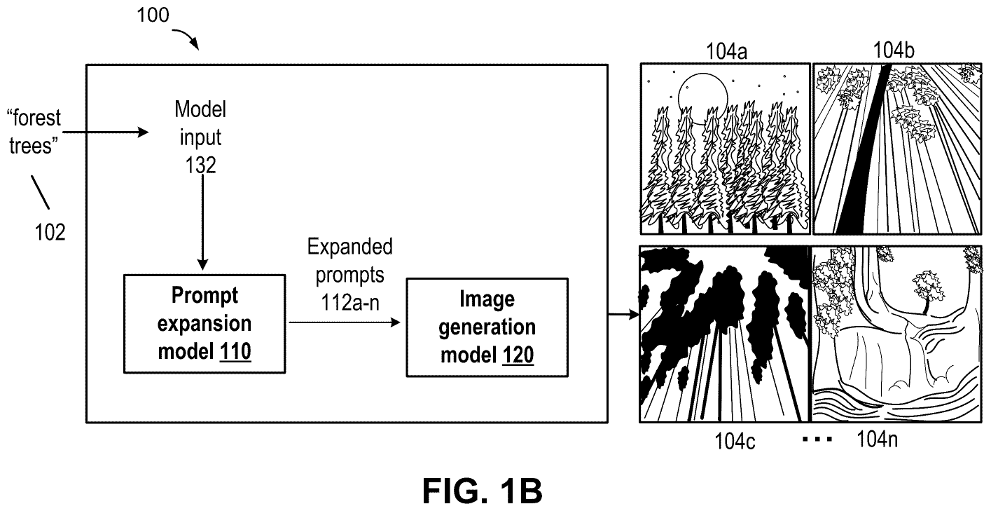

FIG. 1A shows an example image generation system 100. The image generation system 100 is an example of a system implemented as computer programs on one or more computers in one or more locations in which the systems, components, and techniques described below are implemented.

The image generation system 100 generates images 104a-n given an input query 102. Each of the images 104a-n is responsive to the input query 102. At least some of the images 104a-n, or each of the images 104a-n can be unique, that is, different from one another.

To generate images, the system 100 receives a request to generate one or more images. The request can include the input query 102. The input query 102 includes a prompt (e.g., a text prompt) that describes an image. In the example of FIG. 1A, the input query 102 includes “forest trees.”

In some examples, the system can receive the input query 102 from a user. For example, the system 100 can receive the input query 102 from a user by way of an interface, e.g., a graphical user interface, or an application programming interface (API). In particular, a user can provide an input to a user device that includes a request to generate an image and a prompt that describes the content of the image to be generated.

The system 100 processes the input query 102 to generate the images 104a-n. Each image includes multiple pixels. Each pixel has one or more intensity values.

For example, as described below with reference to FIG. 1B, the system 100 can process the input query 102 using a prompt expansion model to generate a set of expanded prompts. The system 100 can then process each of one or more expanded prompts of the set of expanded prompts using an image generation model to generate a respective image of the images 104a-n. In the example of FIG. 1A, each of the images 104a-n depicts a forest of trees with different visual features such as backgrounds, angles, and styles.

In some examples, the system 100 provides the expanded prompts, or the images 104a-n, or both to the user, e.g., for display on a user device of the user, or for storage in a data storage device. In some cases, the system can transmit a generated expanded prompt or generated image to a user device of the user, e.g., by way of a data communication network (e.g., the internet). For example, the system 100 can provide data representing the images 104a-n to the user device.

FIG. 1B shows the example image generation system 100 described with reference to FIG. 1A. In particular, the image generation system 100 generates images 104a-n using a prompt expansion model 110 and an image generation model 120.

The system 100 receives the input query 102 as described above with reference to FIG. 1.

The system 100 processes a model input 132 that includes at least the input query 102 using the prompt expansion model 110 to generate a set of expanded prompts 112a-n of the input query 102. The prompt expansion model 110 is described in further detail below.

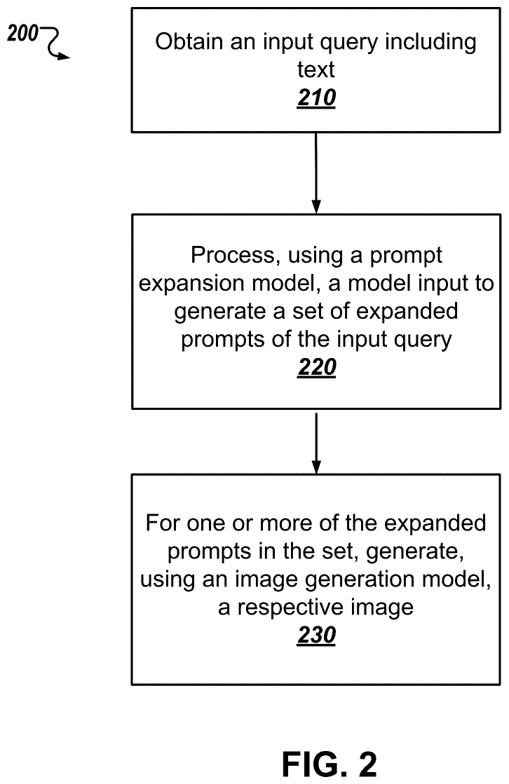

For example, the system 100 can generate the model input 132 to include the input query 102. In some examples, the system 100 can also include one or more prefixes that each characterize a type of expansion between the input query 102 and the expanded prompt in the model input 132. Example types of expansion are described below with reference to FIG. 2. In some examples, the system 100 can receive the one or more prefixes as input from a user. The system 100 can thus provide for controllable generation.

Generally the prompt expansion model 110 processes at least some types of tokens through an embedding layer of the prompt expansion model 110 to generate embeddings of the tokens in an embedding space. For example, the prompt expansion model 110 can process text tokens of the input query 102 through the embedding layer to generate embeddings of the text tokens. The prompt expansion model 110 further processes the embeddings through one or more other layers of the prompt expansion model 110.

In some examples, the system 100 can also include a learned prompt, that has been generated through prompt tuning, in the model input 132. As an example, the learned prompt can include a set of embeddings. The embeddings of the learned prompt can be in the same space of the embeddings of the tokens that are generated by the embedding layer of the prompt expansion model 110. In cases where the model input 132 includes a learned prompt, the prompt expansion model 110 combines, e.g., concatenates, the learned prompt and the embeddings of the tokens generated by the embedding layer for further processing through the one or more other layers of the prompt expansion model 110. Generating the learned prompt is described in further detail below.

Each of the expanded prompts 112a-n can include text that describes an image in more detail than the input query 102. For example, each of the expanded prompts 112a-n can describe an image with a higher level of granularity or specificity than the input query 102. For example, a higher level of granularity or specificity can indicate a semantic expansion, e.g., a larger number of defined features, and/or a detailed expansion, e.g., features that are defined at a higher level of precision.

As a particular example, the expanded prompts 112a-n generated by the prompt expansion model 110 can include keywords or additional details that provide for a semantic expansion with a larger number of defined features, a detailed expansion with features defined at a higher level of precision, or both. The keywords can describe visual features that improve the image quality of the generated image without changing the content of the image, such as art form, artist, medium, style, etc. The additional details can describe visual features or conceptual details such as composition, viewpoint, lighting, subjects to depict, pose, action, point-of-view, background, colors, topic, location, time of day, scenery, etc.

In some examples, the expanded prompts 112a-n can include one or more sub-phrases of the input query. The one or more sub-phrases of the input query can each include a subset of the text of the input query 102. The system can include the one or more sub-phrases in the expanded prompt to ensure adherence to the input prompt. The system can thus generate expanded prompts that remain faithful to details within the input prompt while adding other details.

An example semantic expansion is described next. For example, a prompt that describes an image in more detail can define features of the image, such as visual features or conceptual details, that are not defined in a prompt that describes an image in less detail. As an example, the input query 102 is a less detailed prompt that includes “forest trees.” In the example of FIG. 1B, the expanded prompt 112a is a prompt that describes an image in more detail, which includes “a close up of a forest at night. The moon is rising behind a forest, illuminating the small town in the distance. modern European ink painting,” which defines visual features such as angle and style (“close up” and “modern European ink painting”), as well as conceptual details such as “at night” and “the moon is rising behind a forest.” The expanded prompt 112a thus includes features and conceptual details that are not defined in the input query 102.

An example detailed expansion is described next. For example, for features that are defined in a prompt that describes an image in less detail, a prompt that describes an image in more detail can define the features more precisely. As an example, the input query 102 includes a prompt that describes an image in less detail, which includes “forest trees” as a subject. In the example of FIG. 1B, the expanded prompt 112c is a prompt that describes an image in more detail, which includes, “A forest of tall dark red trees in front of a light blue sky. The trees are all standing around each other, forming a ring around each other. digital art.” The expanded prompt 112c thus defines the subject, “a forest of tall dark red trees,” in more detail than “forest trees” while remaining faithful to the input query 102.

As further examples, in FIG. 1B, the expanded prompt 112b includes “A group of trees standing in a forest. The trees are in full foliage, the sunlight shining brightly, and the forest is at its most alive. futurism.”

The expanded prompt 112n includes “A forest scene that contains a waterfall, a bridge, and a single tree. The tree is at the top of a hill and the water falls into the distance. German romanticism.”

As described above, the expanded prompts 112b and 112n define features such as visual features and conceptual details that are not defined in the input query 102.

The system 100 processes the expanded prompts 112a-n to generate the images 104a-n. For example, for one or more of the expanded prompts 112a-n, the system 100 can process the expanded prompt to generate a respective image that represents the expanded prompt using the image generation model 120. The system 100 can provide each of one or more of the expanded prompts 112a-n as input to the image generation model 120 to generate the respective image that represents the expanded prompt. The image generation model 120 is described in further detail below.

The prompt expansion model 110 can generally be any appropriate neural network that is configured to generate an output including text given an input including text. For example, the prompt expansion model 110 can include a pre-trained language model neural network. The language model neural network can have any of a variety of Transformer-based neural network architectures, e.g., encoder-decoder Transformer architectures, decoder-only Transformer architectures, other attention-based architectures, and so on.

Examples of such architectures include those described in Aakanksha Chowdhery, et al. PaLM: Scaling Language Modeling with Pathways, arXiv preprint arXiv: 2204.02311; Rohan Anil, et al. Palm 2 technical report. arXiv preprint arXiv: 2305.10403, 2023; and Gemini Team, et al., Gemini: a family of highly capable multimodal models. arXiv preprint arXiv: 2312.11805, 2023.

The language model neural network can be configured to generate output sequences made up of tokens from a vocabulary. In some examples, the vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text, such as images, videos, or audio. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

Prior to using the language model neural network to generate model outputs, the language model neural network is pre-trained e.g., by the system 100 or by one or more other systems.

For example, the system 100 or another system can pre-train the language model neural network on a language modeling task, e.g., a task that requires predicting, given a current sequence of text tokens, the next token that follows the current sequence in the training data. Equivalently, the language modeling task can require, for each given unlabeled text sequence in a training data set, predicting a text sequence that followed the given unlabeled text sequence in a corresponding document. As a particular example, the language model neural network can be pre-trained on a maximum-likelihood objective on a large dataset of text, e.g., text that is publicly available from the Internet or another text corpus. In some examples, the system 100 or another system can pre-train the language model neural network using other machine learning training techniques, e.g., supervised fine tuning, reinforcement learning from human feedback, instruction tuning, etc.

After training, the system 100 can be configured to use the language model neural network to generate an expanded prompt that includes a sequence of text tokens for a given input prompt that includes a sequence of text tokens.

In some implementations, the prompt expansion model 110 can have been further trained by a training system of the system 100 or another training system to generate expanded prompts. In some examples, the training system can further train the prompt expansion model 110 to generate expanded prompts of certain types of expansion, lengths, or style.

For example, the learned prompt can have parameters that have been learned while holding pre-trained parameters of the prompt expansion model 110 fixed. The learned prompt can have been learned based on tuning data. As an example, the training system can further train the pre-trained language model neural network on tuning data by updating parameters for a learned prompt while holding the pre-trained parameters of the pre-trained language model neural network fixed. For example, the learned prompt can include a set of embeddings as described above. The learned prompt can be learned by freezing the parameters of the prompt expansion model 110 and updating only the sets of embedding weights that correspond to the learned prompt over a sequence of training iterations. The learned prompt can thus cause the prompt expansion model 110 to generate an expanded prompt conditioned on, e.g., a style, format, desired length, or types of visual features or additional details represented by the tuning data. More details on using prompt tuning are described in Lester, B., et. al: “The Power of Scale for Parameter-Efficient Prompt Tuning” (arXiv:2104.08691v2).

As another example, the training system can fine-tune the pre-trained language model neural network on the tuning data.

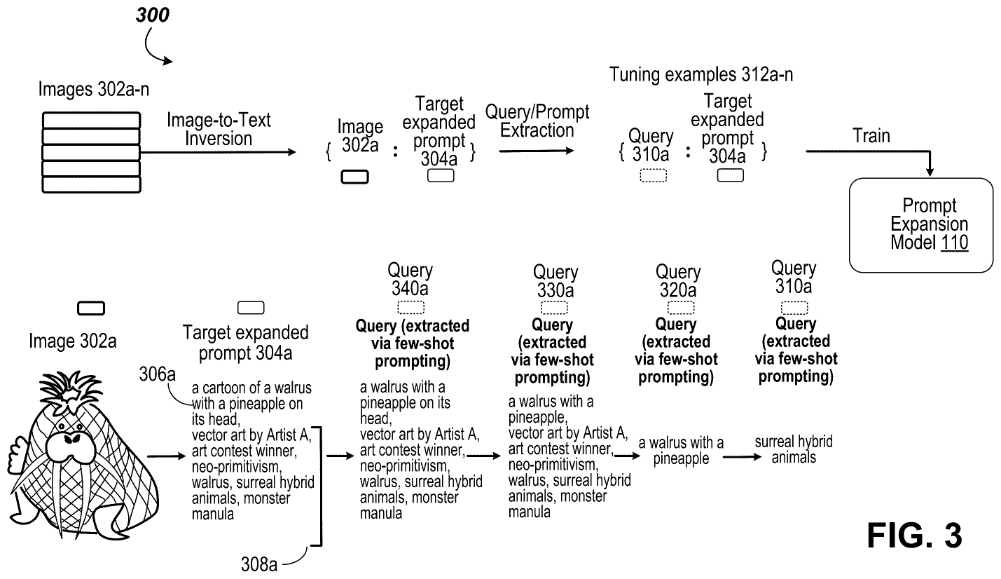

The tuning data includes multiple tuning examples. Each tuning example includes a tuning input that includes a query and a corresponding tuning output that includes a target expanded prompt that describes an image in more detail than the query. Generating the tuning data is described in further detail below with reference to FIG. 3.

In some cases, different image generation models, e.g., image generation models with different architecture, image generation models at different training checkpoints, or image generation models that have been trained on different sets of training data, can perform differently on given expanded prompts. For example, a particular image generation model may consistently fail to generate images of a particular style identified in given expanded prompts if the particular image generation model was not trained on training data that included images of the particular style.

In some implementations, the prompt expansion model 110 can be further trained on model-specific tuning data, also referred to as re-fine-tuning data. For example, a training system of the system 100 or another training system can further train the prompt expansion model 110 on the model-specific tuning data to align the generated expanded prompts to the particular image generation model 120.

The model-specific tuning data includes multiple model-specific tuning examples, also referred to as re-fine-tuning examples. Each model-specific tuning example can include a model-specific tuning input that includes a query and a corresponding model-specific tuning output that includes a target expanded prompt. In some examples, the model-specific tuning examples can be selected from a set of unseen training examples from training data for the prompt expansion model based on a score representing a renderability of the target expanded prompt by the image generation model. An example of generating the score is described below. An example set of training data for the prompt expansion model can include the tuning data described with reference to FIG. 3.

For each unseen training example, the system can use the prompt expansion model 110 to generate an expanded prompt for the query of the training example. The system can provide the expanded prompt as input to the image generation model 120 to generate an image for the training example.

For each generated image, the system can determine a score for the image using a weighted average of a query-image embedding distance and prompt-image embedding distance. The score represents the renderability of the target expanded prompt by the image generation model 120. For example, the score can be calculated as a weighted average of the query-image embedding distance and prompt-image embedding distance: a×embedding_distance(q, I(p))+b×embedding_distance(p, I(p)), where a and b are weights, and embedding_distance(q, I(p)) is the query-image embedding distance and embedding_distance(p, I(p)) is the prompt-image embedding distance.

The query-image embedding distance is the distance in a joint image and text embedding space between an embedding of the query of the training example, and an embedding of the generated image. For example, the system can generate the embedding of the query of the training example using an embedding model that is configured to map text and images to a joint image and text embedding space, e.g., an embedding model of a COCA model. The system can generate the embedding of the generated image using the embedding model.

The prompt-image embedding distance is the distance in the joint image and text embedding space between an embedding of the expanded prompt, and an embedding of the generated image. For example, the system can generate the embedding of the expanded prompt using the embedding model. The system can generate the embedding of the generated image using the embedding model.

The system selects training examples for which the score for the image generated for the query of the training example meets a threshold score to include in the model-specific tuning examples. The system can thus further train the prompt expansion model 110 on model-specific tuning examples that include queries for which the prompt expansion model 110 generates expanded prompts that the image generation model 120 can faithfully generate high-quality images for. The system can thus improve the quality of generated images by further training the prompt expansion model 110 to generate expanded prompts that the image generation model 120 is responsive to.

In some implementations, the system 100 can determine to further train the prompt expansion model 110 on model-specific tuning data based on the performance of the image generation model 120. For example, the system 100 can generate images for a test set of queries as described above. Each query in the test set can include one of multiple keywords. For each generated image, the system 100 can determine a similarity score that is a combination, e.g., average, of a query-image embedding distance, and a prompt-image embedding distance. The system 100 can determine an average similarity score for each of the keywords using the similarity scores for queries that include the keyword. The system 100 can rank the keywords in descending order of similarity scores. The system 100 can determine to further train the prompt expansion model 110 in response to determining that one or more of the differences between the similarity scores for the top-k keywords in the ranking and the similarity scores for the bottom-k keywords in the ranking meets a threshold difference. Thus the system 100 can determine that the image generation model 120 is not responsive to at least some keywords, e.g., the bottom-k keywords in the ranking. The system 100 can further train the prompt expansion model 110 on the model-specific tuning examples as described above.

The image generation model 120 can include a text-to-image model that is configured to generate an output that includes an image that is described by an input text prompt. The image generation model 120 can have any appropriate neural network architecture for generating images that are described by input text prompts.

For example, the image generation model 120 can include a multimodal language model neural network such as Gemini, described in Gemini Team, et al. Gemini: a family of highly capable multimodal models. arXiv preprint arXiv:2312.11805 (2023). As another example, the image generation model 120 can include a neural network such as Muse, described in Chang et al., Muse: Text-To-Image Generation via Masked Generative Transformers, arXiv preprint arXiv:2301.00704 (2023) or Parti, described in Yu et al., Scaling Autoregressive Models for Content-Rich Text-to-Image Generation, arXiv preprint arXiv:2206.10789 (2022).

As another example, the image generation model 120 can include a text-conditioned diffusion model such as Imagen, described in Saharia et al., Photorealistic Text-to-Image Diffusion Models with Deep Language Understanding, arXiv preprint arXiv:2205.11487 (2022).

As a particular example, the image generation model 120 can include a text encoder and a conditional diffusion model. The system 100 can process each of the n expanded prompts using the text encoder to generate n text embeddings. The system 100 can process each of the n text embeddings, and n noise samples, using the conditional diffusion model to generate n images.

FIG. 2 is a flow diagram of an example process 200 for generating images. For convenience, the process 200 will be described as being performed by a system of one or more computers located in one or more locations. For example, an image generation system, e.g., the image generation system 100 of FIGS. 1A-1B, appropriately programmed in accordance with this specification, can perform the process 200.

The system obtains an input query including text (step 210). The input query includes a description of an image.

The system processes, using a prompt expansion model, a model input to generate a set of expanded prompts of the input query (step 220). For example, the system can generate each of the expanded prompts in the set by sampling from the prompt expansion model given the model input.

Each of the expanded prompts describes an image in more detail than the input query. For example, each of the expanded prompts in the set can include any one or more of: keywords, additional details, or one or more sub-phrases of the input query.

In some examples, the system can generate expanded prompts that each describe an image in more detail than the input query and of one or more particular types of expansion. The system can receive an input prompt that includes one or more prefixes and generate an expanded prompt of the types of expansion indicated by the prefixes. For example, a prefix (e.g., “ABST” as shown below in Table 1) can indicate that the prompt expansion model should output expanded prompts conditioned on the input prompt being an abstract query, so that the expanded prompts add details and expand on the input prompt conceptually. As another example, a prefix can indicate that the prompt expansion model should output expanded prompts conditioned on the input prompt being a detailed query, so that the expanded prompts add details while remaining faithful to the input prompt. Other prefixes can indicate, for example, that the prompt expansion model should output expanded prompts that should return images that have a threshold aesthetic score, the prompt expansion model should output expanded prompts that include sub-phrases of the input query (e.g., “GRD” as shown below in Table 1), the prompt expansion model should output expanded prompts that include an example of the input query (e.g., “SPCT” as shown below in Table 1), the prompt expansion model should output expanded prompts that are optimized for the particular image generation model, or the prompt expansion model should output expanded prompts that are suitable for multistep prompt expansion (e.g., “MSTP” as shown below in Table 1).

Some example types of expansion, model inputs with example prefixes, and expanded prompts are shown below in Table 1.

TABLE 1
Example types of expansion, model inputs, and expanded prompts

| Type of | | |
|---|---|---|
| expansion | Model input | Expanded prompt |
| Abstract | ABST hope | A tunnel with a light at the far end |
| Grounded | GRD colossal dragon | A colossal dragon eating humans |
| | GRD monster bike | A monster bike being ridden by a |
| | | daredevil |
| Specificity | SPCT animal drawings | Animal drawings, for example a |
| | | children's drawing of a dog |
| | SPCT groups of animals | Groups of animals, specifically a herd of |
| | | sheep being gathered by a farmer |
| Multi-step | MSTP a brain on a wall | a brain on a wall, poster art by Artist A |
| expansion | MSTP a brain on a wall, poster art | a brain on a wall, poster art by Artist A, |
| | by Artist A | featured on Website A |
| | MSTP a brain on a wall, poster art | a brain on a wall, poster art by Artist A, |
| | by Artist A, featured on Website A | featured on Website A, colorful art, |
| | | colorful artwork, brains, 8k archival |
| | | print |
| | MSTP a brain on a wall, poster art | a picture of a brain on a wall, poster art |
| | by Artist A, featured on Website A, | by Artist A, featured on Website A, |
| | colorful art, colorful artwork, | colorful art, colorful artwork, brains, 8k |
| | brains, 8k archival print | archival print |

In one example, the model input includes one or more prefixes that each characterize a type of expansion between the input query and the expanded prompt. The prompt expansion model is configured to generate an expanded prompt of the one or more types of expansion characterized by the one or more prefixes for a given query.

The prompt expansion model can include a pre-trained language model neural network that has been further trained, e.g., fine-tuned, on multiple training examples. Each training example can include (i) a training input that includes a query and one or more prefixes and (ii) a corresponding target output that includes a target expanded prompt, where the target expanded prompt describes an image in more detail than the query and of the one or more types of expansion characterized by the one or more prefixes of the training input. Thus the prompt expansion model can be trained to recognize the one or more prefixes of a given model input and to generate expanded prompts of the one or more types of expansion characterized by the one or more prefixes.

In some examples, the system can derive the training examples from the tuning dataset described below with reference to FIG. 3. For example, for each training example, the system can include the query of the tuning input, and one or more prefixes, in the training input, and the target expanded prompt of the corresponding tuning output in the corresponding target output. In some examples, the system can assign the one or more prefixes to the training input by processing the query of the tuning input and the target expanded prompt of the corresponding tuning output, e.g., using a language model neural network, to determine a prefix for the type of expansion.

In some examples, the query of the tuning input can include the one or more prefixes. For example, in cases where the system generates training examples using few-shot prompt examples, as described below with reference to FIG. 3, each few-shot prompt example can include a few-shot query and a corresponding few-shot prompt for one or more particular types of expansion. In these examples, the system can include the one or more prefixes characterizing the one or more types of expansion in the query.

In some examples, the system can generate expanded prompts of different types of expansion without prefixes in the input prompt. For example, the prompt expansion model can be configured to generate an expanded prompt of one or more types of expansion for a given query based on the given query. That is, the prompt expansion model can be trained to infer a query type based on the query such that the type of expansion fits the query.

For example, the prompt expansion model can include a pre-trained language model that has been further trained on multiple training examples using a curriculum learning technique. One or more of the training examples can include (i) a training input that includes a query and one or more prefixes that each characterize a type of expansion between a target expanded prompt and the query and (ii) a corresponding target output that includes the target expanded prompt, where the target expanded prompt describes an image in more detail than the query and of the one or more types of expansion characterized by the one or more prefixes.

The system can train the prompt expansion model over a sequence of training iterations. At each training iteration, the system can train the prompt expansion model on one or more training examples for the training iteration. The system can perform prefix dropout, or remove the one or more prefixes from the training input, for a proportion of the training examples for each training iteration. For example, for each training iteration, the system can obtain the batch for the training iteration by removing the one or more prefixes from the training input according to the proportion for the training iteration. In some examples, the proportion for each training iteration can increase over the sequence of training iterations. Thus the system can improve the performance of the prompt expansion model at inference by controlling the type of expansion based on the query, without having to select and provide one or more prefixes in the model input. For example, the system can control the type of expansion without having to select a prefix from a predefined set of prefixes of the training examples for the prompt expansion model.

For one or more of the expanded prompts in the set, the system generates, using an image generation model, a respective image (step 230). The respective image for the expanded prompt represents the expanded prompt.

In some implementations, the system filters the expanded prompts in the set. For example, the system selects a subset of expanded prompts that are the most diverse from each other and uses only the selected subset to generate images.

For example, the system can process each expanded prompt in the set to generate a respective text embedding of the expanded prompt. As a particular example, the system can process each expanded prompt using a text embedding neural network to generate the respective text embedding.

The system can identify a subset of expanded prompts from the set of expanded prompts. For example, the system can identify the subset of expanded prompts where the respective text embeddings of the expanded prompts in the subset have a highest variance among other subsets of expanded prompts within the set of expanded prompts.

For each expanded prompt within the subset of expanded prompts, the system can generate a respective image that represents the expanded prompt using the image generation model. Thus the system can maximize the diversity of the images that are generated while reducing the amount of computing resources that would otherwise be required to generate images for all of the expanded prompts in the set.

In some implementations, the system filters the generated images. For example, the system selects a subset of the generated images that are the most diverse from each other for which to provide for display to a user. For example, the system can process each generated respective image to generate a respective image embedding of the generated respective image. As a particular example, the system can process each generated respective image using an image embedding neural network. The system can identify a subset of generated respective images where the respective image embeddings of the generated respective images in the identified subset have a highest variance among other subsets of generated respective images. For each generated respective image within the subset of generated respective images, the system can provide the generated respective image for display to a user. Thus the system can maximize the diversity of images that are provided for display to the user while reducing the amount of computing resources that would otherwise be required to transmit and display all of the generated images.

In some implementations, the system can support multi-step generation for a gradual increase in detail. The system can generate expanded prompts with multiple steps of expansion based on input length and output length. For example, the system can generate a particular image using multiple expanded prompts. The expanded prompt from a first step of expansion can be the input prompt for a second step of expansion.

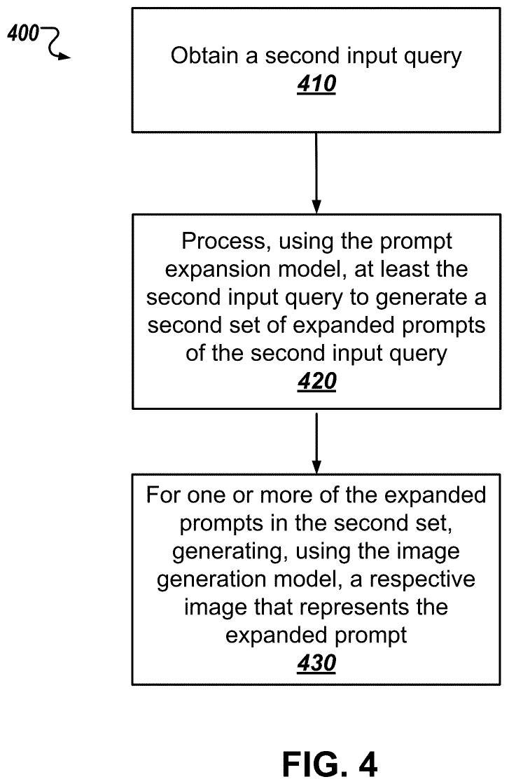

In some of these examples, the model input can include a multi-step prefix that characterizes the type of expansion as using multiple expanded prompts. Generating images using multiple expanded prompts is described below with reference to FIG. 4.

FIG. 3 shows an example process 300 for generating a tuning dataset for further training a prompt expansion model. For convenience, the process 300 will be described as being performed by a system of one or more computers located in one or more locations. For example, an image generation system, e.g., the image generation system 100 of FIGS. 1A-1B, appropriately programmed in accordance with this specification, can perform the process 300.

The tuning dataset includes multiple tuning examples 312a-n. Each tuning example includes a tuning input that includes a query and a corresponding tuning output that includes a target expanded prompt. FIG. 3 shows an example tuning example 312a that includes a query 310a and a target expanded prompt 304a. In the example of FIG. 3, the query 310a includes “surreal hybrid animals” and the target expanded prompt 304a includes “a cartoon of a walrus with a pineapple on its head, vector art by Artist A, art contest winner, neo-primitivism, walrus, surreal hybrid animals, monster manula.”

To generate the tuning examples 312a-n, the system receives images 302a-n. FIG. 3 shows an example image 302a.

The system processes each of the images 302a-n to generate a target expanded prompt 304a-n for the image 302a-n. For example, one or more of the target expanded prompts can include a caption and a set of feature values for one or more features describing the image. In some examples, the target expanded prompt can include conceptual details for the query, or one or more sub-phrases of the query, or both. FIG. 3 shows the example target expanded prompt 304a, with a caption 306a and a set of feature values 308a.

The caption is a natural language description of the content of the image. In the example of FIG. 3, the caption 306a includes “a cartoon of a walrus with a pineapple on its head.”

The system can process the image using a text captioning model to generate the caption for the image. The text captioning model is configured to perform image processing tasks such as generating text describing a given image. As an example, the text captioning model can include a visual language model neural network. Some example text captioning models with which the techniques described herein may be used include: Flamingo (Alayrac et al. arXiv:2204.14198); ALIGN (Jia et al., arXiv:2102.05918); PaLI (Chen et al. arXiv:2209.06794) and PaLI-X (Chen et al. arXiv:2305.18565); and Gemini (“Gemini: A Family of Highly Capable Multimodal Models, Gemini Team, Google”). These references also include indications of training datasets that may be used to train the respective models.

The one or more features describing the image can include visual features such as art form (e.g., vector art), artist, medium (e.g., art contest winner), or style (e.g., photorealistic). Each feature can have multiple potential feature values. In the example of FIG. 3, the set of feature values 308a includes “vector art by Artist A, art contest winner, neo-primitivism, walrus, surreal hybrid animals, monster manula.”

The set of feature values can be generated by processing each potential feature value for each feature and the image to determine a distance between a text embedding of the potential feature value and an image embedding of the image. For example, for each feature, the system can generate a text embedding of each potential feature value for the feature, and an image embedding of the image. For example, the system can generate the text embedding of each potential feature value for the feature using an embedding model, e.g., the embedding model described above. The system can generate the image embedding of the image using the embedding model.

For each feature, the system can identify the feature value that has a text embedding that is most similar to the image embedding. The system can include the identified feature value for each feature in the target expanded prompt for the image.

The system processes the target expanded prompt using a text generation model to generate the query. The query describes the image in less detail than the target expanded prompt. For example, the system can process an input that includes the target expanded prompt and multiple few-shot prompt examples that each include a few-shot query and a corresponding few-shot prompt. Each few-shot prompt describes an image in more detail than the corresponding few-shot query.

In some examples, each few-shot prompt example can include a few-shot query and a corresponding few-shot prompt for one or more particular types of expansion. In these examples, the system can include one or more prefixes characterizing the one or more types of expansion in the query.

The text generation model can have the same architecture as or a similar architecture to the pre-trained prompt expansion model.

In some examples, each target expanded prompt can correspond to multiple tuning inputs that include different queries. For example, each of the different queries are suitable to map to the target expanded prompt, but can each have a different length or level of detail. In the example of FIG. 3, the query 340a, 330a, 320a, and 310a each include a different level of detail.

In some examples, the system can generate each of the different queries by successively processing different inputs. Each input can include a previously generated query and few-shot examples derived from the few-shot examples used to generate the previously generated query. For example, the system can generate the query 340a by processing a first input that includes the target expanded prompt 304a and few-shot examples that include few-shot prompts of a similar level of detail as the target expanded prompt 304a, and few-shot queries of a similar level of detail as the query 340a. The system can generate the query 330a by processing a second input that includes the query 340a, and few-shot examples that include few-shot prompts that include the few-shot queries of the first input, and few-shot queries of a similar level of detail as the query 330a. The system can thus generate queries of increasingly fewer levels of detail for the same target expanded prompt 304a. The system can include the target expanded prompt 304a and each of the queries in different tuning examples.

In some examples, the system can generate each of the different queries by processing an input that includes the target expanded prompt and multiple few-shot examples of different levels of detail. For example, each few-shot example can include a few-shot query and a corresponding few-shot prompt, and multiple of the few-shot queries can correspond to the same few-shot prompt. For example, the different few-shot queries can describe an image in different levels of detail. The system can process the input using the text generation model to generate multiple queries according to the few-shot prompts of the few-shot examples. The system can include the target expanded prompt and each of the queries in different tuning examples.

FIG. 4 shows an example process 400 for generating an image using multiple expanded prompts. For convenience, the process 400 will be described as being performed by a system of one or more computers located in one or more locations. For example, an image generation system, e.g., the image generation system 100 of FIGS. 1A-1B, appropriately programmed in accordance with this specification, can perform the process 400.

The system obtains a second input query (step 410). The second input query includes one of the set of expanded prompts generated using the prompt expansion model generated in step 220 described above with reference to FIG. 2.

In some examples, the system can obtain the second input query from a user. For example, the system can provide the set of expanded prompts for display to the user. The system can receive data identifying one of the expanded prompts as the second input query.

The system processes, using the prompt expansion model, at least the second input query to generate a second set of expanded prompts of the second input query (step 420). For example, the system can generate the second set of expanded prompts similarly to generating the set of expanded prompts described above with reference to step 220 of FIG. 2.

In some implementations, the prompt expansion model can have been further trained on multi-step data. The multi-step data includes multi-step examples that each include a multi-step input that includes a first prompt and a corresponding multi-step output that includes a second prompt. The second prompt includes more details than the first prompt.

In some examples, a first multi-step input of a first multi-step example includes a second multi-step output of a second multi-step example. For example, the first prompt of the second multi-step example can describe an image at a certain level of detail, and the second prompt of the second multi-step example can describe the image at a greater level of detail than the first prompt. As an example, referring to FIG. 3, the second multi-step example can include the query 310a as the first prompt, and the query 320a as the second prompt.

The first prompt of the first multi-step example can include the second prompt of the second multi-step example, and the second prompt of the first multi-step example can describe the image at a greater level of detail than the first prompt of the first multi-step example. As an example, referring to FIG. 3, the first multi-step example can include the query 320a as the first prompt, and the query 330a as the second prompt.

In some examples, the second prompt has a longer length than the first prompt. For example, the second prompt can be generated by concatenating the first prompt with one or more sub-phrases from an alternative prompt to the first prompt. For example, the system can process the first prompt using the prompt expansion model to generate multiple alternative prompts. The system can include one or more sub-phrases of the alternative prompts in the second prompt, where the one or more sub-phrases include additional details that are not present in the first prompt.

For one or more of the expanded prompts in the second set, the system generates, using the image generation model, a respective image that represents the expanded prompt (step 430). For example, the system can generate the respective image similarly to generating the respective image described above with reference to step 230 of FIG. 2.

Although this specification describes generating an image using two expanded prompts, the system can generate an image using a larger number of expanded prompts, e.g., 3, 5, or 10 expanded prompts, each generated using a previously generated expanded prompt. For example, the system can repeatedly perform the process 400 to generate further sets of expanded prompts. Thus the system allows the user to iterate on the expanded prompts without manually prompt engineering the text.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining an input query comprising text;
processing, using a prompt expansion model, a model input comprising at least the input query to generate a set of expanded prompts of the input query, wherein each of the expanded prompts describes an image in more detail than the input query; and
for one or more of the expanded prompts in the set, generating, using an image generation model, a respective image that represents the expanded prompt.

2. The method of claim 1, wherein obtaining an input query comprises receiving the input query from a user.

3. The method of claim 1, wherein each of the expanded prompts in the set comprise any one or more of: keywords, additional details, or one or more sub-phrases of the input query.

4. The method of claim 1, further comprising providing each of the generated respective images for display to a user.

5. The method of claim 1, wherein processing, using a prompt expansion model, a model input comprising at least the input query to generate a set of expanded prompts of the input query comprises:
generating each of the expanded prompts in the set by sampling from the prompt expansion model given the model input.

6. The method of claim 1, wherein the model input comprises a learned prompt that has been generated through prompt tuning.

7. The method of claim 6, wherein the learned prompt has been learned based on tuning data.

8. The method of claim 7, wherein the tuning data comprises a plurality of tuning examples, each comprising a tuning input comprising a query and a corresponding tuning output comprising a target expanded prompt, wherein the target expanded prompt describes an image in more detail than the query.

9. The method of claim 8, wherein one or more of the target expanded prompts comprises a caption and a set of feature values for one or more features describing an image.

10. The method of claim 9, wherein the caption is generated by processing the image using a text captioning model that is configured to generate text describing a given image.

11. The method of claim 9, wherein the set of feature values for a plurality of features is generated by processing each potential feature value for each feature and the image to determine a distance between a text embedding of the potential feature value and an image embedding of the image.

12. The method of claim 8, wherein the query is generated by processing the target expanded prompt using a text generation model that is configured to generate a query for a given prompt, wherein the text generation model is configured to process an input comprising the target expanded prompt and a plurality of few-shot examples, each comprising a few-shot query and a corresponding few-shot prompt.

13. The method of claim 1, wherein for one or more of the expanded prompts in the set, generating, using an image generation model, a respective image that represents the expanded prompt comprises:
processing each expanded prompt in the set to generate a respective text embedding of the expanded prompt;
identifying a subset of expanded prompts, wherein the respective text embeddings of the expanded prompts in the identified subset have a highest variance among other subsets of expanded prompts within the set of expanded prompts; and
for each expanded prompt within the subset of expanded prompts, generating, using the image generation model, the respective image that represents the expanded prompt.

14. The method of claim 1, further comprising, for each generated respective image:
processing the generated respective image to generate a respective image embedding of the generated respective image;
identifying a subset of generated respective images, wherein the respective image embeddings of the generated respective images in the identified subset have a highest variance among other subsets of generated respective images; and
for each generated respective image within the subset of generated respective images, providing the generated respective image for display to a user.

15. The method of claim 1, wherein the prompt expansion model is configured to generate an expanded prompt of one or more types of expansion for a given query based on the given query.

16. The method of claim 15, wherein the prompt expansion model comprises a pre-trained language model that has been further trained on a plurality of training examples, wherein one or more of the plurality of training examples comprises (i) a training input comprising a query and one or more prefixes that each characterize a type of expansion between a target expanded prompt and the query and (ii) a corresponding target output comprising the target expanded prompt, wherein the target expanded prompt describes an image in more detail than the query and of the one or more types of expansion characterized by the one or more prefixes.

17. The method of claim 1, wherein for each expanded prompt, the model input further comprises one or more prefixes that each characterize a type of expansion between the input query and the expanded prompt, and wherein the prompt expansion model is configured to generate an expanded prompt of the one or more types of expansion characterized by the one or more prefixes for a given query.

18. The method of claim 17, wherein the prompt expansion model comprises a pre-trained language model that has been further trained on a plurality of training examples, each comprising (i) a training input comprising a query and one or more prefixes and (ii) a corresponding target output comprising a target expanded prompt, wherein the target expanded prompt describes an image in more detail than the query and of the one or more types of expansion characterized by the one or more prefixes.

19. The method of claim 1, wherein the prompt expansion model has been further trained on re-fine-tuning data, wherein the re-fine-tuning data comprises a plurality of re-fine-tuning examples, each comprising a re-fine-tuning input comprising a query and a corresponding re-fine-tuning output comprising a target expanded prompt, wherein the re-fine-tuning examples are selected from a set of unseen training examples from training data for the prompt expansion model based on a score representing a renderability of the target expanded prompt by the image generation model.

20. The method of claim 1, wherein the model input further comprises a multi-step prefix, and wherein the method further comprises:
obtaining a second input query comprising one of the set of expanded prompts generated using the prompt expansion model;
processing, using the prompt expansion model, at least the second input query to generate a second set of expanded prompts of the second input query; and
for one or more of the expanded prompts in the second set, generating, using the image generation model, a respective image that represents the expanded prompt.

21. A system comprising:
one or more computers; and
one or more storage devices storing instructions that, when executed by the one or more computers, cause the one or more computers to perform operations comprising:
obtaining an input query comprising text;
processing, using a prompt expansion model, a model input comprising at least the input query to generate a set of expanded prompts of the input query, wherein each of the expanded prompts describes an image in more detail than the input query; and
for one or more of the expanded prompts in the set, generating, using an image generation model, a respective image that represents the expanded prompt.

22. One or more computer-readable storage media storing instructions that when executed by one or more computers cause the one or more computers to perform operations comprising:
obtaining an input query comprising text;
processing, using a prompt expansion model, a model input comprising at least the input query to generate a set of expanded prompts of the input query, wherein each of the expanded prompts describes an image in more detail than the input query; and
for one or more of the expanded prompts in the set, generating, using an image generation model, a respective image that represents the expanded prompt.
